(19) United States
(12) Patent Application Publication
(10) Pub. No.: US 2016/0292055 A1
(43) Pub. Date: Oct. 6, 2016

(54) FAILURE RECOVERY IN AN ASYNCHRONOUS REMOTE MIRRORING PROCESS

(71) Applicant: Infinidat LTD., Herzliya (IL)

(72) Inventor: Ayelet Shani, Moshav Herev le'et (IL)

(21) Appl. No.: 14/676,837

(22) Filed: Apr. 2, 2015

(51) Int. Cl. G06F 11/20; G06F 3/06

(52) U.S. Cl. CPC G06F 11/2069; G06F 11/2094; G06F 3/0619; G06F 3/065; G06F 3/067; G06F 2201/805

(57) ABSTRACT

A method for generating a remote replicate of a logical entity, the method may include: calculating, by a local site, a replication cycle content that is associated with a replication cycle; wherein the replication cycle content represents differences in contents of logical entity portions between a point in time associated with the replication cycle and a point in time associated with an adjacent replication cycle that preceded the replication cycle; attempting to transmit messages that include the replication cycle content to a remote site and according to a predefined order that is responsive to addresses of the logical entity portions; monitoring a successful reception of the messages that include the replication cycle content by the remote site; wherein when finding that a first part of the replication cycle content was successfully received by the remote site and a second part of the replication cycle content was not successfully received by the remote site due to the failure then transmitting, after recovering from the failure, messages that include the second part; wherein the second part is detected using (a) at least one replication cycle identifier that identifies the replication cycle, and (b) at least one address of at least one logical entity portion.

### BACKGROUND

Remote replication in storage systems is used to replicate logical volumes of a primary (also called ‘local’) site to a secondary (also called ‘remote’) site.

In asynchronous remote replication, batches of updates are periodically sent to the remote site. The batches of updates are performed in replication cycles.

The content of each replication cycle includes the differences that occurred in the logical volume to be replicated, since the previous replication cycle. The content of the replication cycle is transmitted to the remote site. The term “difference” refers to data that was changed since the previous replication cycle and the respective range of addresses within the logical volume, where the changed data is stored.

Each replication cycle is associated with a point in time. The content of a replication cycle can be calculated by comparing (a) a snapshot of the logical volume at a point of time that is associated with the replication cycle to (b) a snapshot of the logical volume at a point of time that is associated with a last replication cycle that preceded the replication cycle.

However, the content of the replication cycle may be determined by using other techniques as well.

The local system transmits all the content of the replication cycle to the remote site. Upon successful completion of the replication cycle, after the content of the replication cycle is stored in the replicated logical volume, a snapshot of the replicated logical volume may also be taken at the remote site to reflect a valid replica of the logical volume and can be used for restoring a compatible and consistent state of the replicated logical volume, in case of a restart after failure of the remote site, when the consistency state of the current version of the replicated logical volume is unknown.

Alternatively, the remote site may log the differences included in the content of the replication cycle in a temporary space and store the differences in the replicated logical volume only when the replication cycle is successfully completed.

Generally, when the local site gets disconnected from the remote site during a replication cycle, either due to communication failure or due to a failure of either of the sites, there is a need to perform a recovery process.

During the recovery process the remote site should revert to a state reflected by a previous replication cycle and the local site must transmit to the remote site the entire content of the replication cycle (all of the differences that are included in the replication cycle)—as it is not known which of the differences were received and stored by the remote site.

When a content of a replication cycle is considerable large (for example—due to large differences between the points of time of successive replication cycles, when the replication cycle is an initial replication cycle or when a replication cycle occurs after a long disconnection), there is a need to resume the replication cycle from the point of failure without regressing to an older version of the replicated logical volume.

### SUMMARY

According to an embodiment of the invention various methods may be provided and are described in the specification. According to various embodiments of the invention there may be provided a non-transitory computer readable medium that may store instructions for performing any of the methods described in the specification and any steps thereof, including any combinations of same. Additional embodiments of the invention include a storage system arranged to execute any or all of the methods described in the specification above, including any stages—and any combinations of same.

According to an embodiment of the invention there may be provided a method for generating a remote replicate of a logical entity, the method may include: calculating, by a local site, a replication cycle content that may be associated with a replication cycle; wherein the replication cycle content represents differences in contents of logical entity portions between a point in time associated with the replication cycle and a point in time associated with an adjacent replication cycle that preceded the replication cycle; attempting to transmit messages that include the replication cycle content to a remote site and according to a predefined order that may be responsive to addresses of the logical entity portions; monitoring a successful reception of the messages that include the replication cycle content by the remote site; and wherein when finding that a first part of the replication cycle content was successfully received by the remote site and a second part of the replication cycle content was not successfully received by the remote site due to the failure then transmitting, after recovering from the failure, messages that include the second part; wherein the second part may be detected using (a) at least one replication cycle identifier that identifies the replication cycle, and (b) at least one address of at least one logical entity portion.

According to an embodiment of the invention there may be provided a non-transitory computer readable medium that stores instructions that once executed a local site causes the local site to execute the steps of: calculating, by a local site, a replication cycle content that may be associated with a replication cycle; wherein the replication cycle content represents differences in contents of logical entity portions between a point in time associated with the replication cycle and a point in time associated with an adjacent replication cycle that preceded the replication cycle; attempting to transmit messages that include the replication cycle content to a remote site and according to a predefined order that may be responsive to addresses of the logical entity portions; monitoring a successful reception of the messages that include the replication cycle content by the remote site; wherein when finding that a first part of the replication cycle content was successfully received by the remote site and a second part of the replication cycle content was not successfully received by the remote site due to the failure then transmitting, after recovering from the failure, messages that include the second part; and wherein the second part may be detected using (a) at least one replication cycle identifier that identifies the replication cycle, and (b) at least one address of at least one logical entity portion.

According to an embodiment of the invention there may be provided a local site that may include a local replication unit and at least one memory module; wherein the local replication unit may be configured to: calculate a replication cycle content that may be associated with a replication cycle and may be stored in the at least one memory module; wherein the replication cycle content represents differences in contents of logical entity portions between a point in time associated with the replication cycle and a point in time associated with an adjacent replication cycle that preceded the replication cycle; attempt to transmit messages that include the replication cycle content to a remote site and according to a predefined order that may be responsive to addresses of the logical entity portions; monitor a successful reception of the messages that include the replication cycle content by the remote site; wherein when finding that a first part of the replication cycle content was successfully received by the remote site and a second part of the replication cycle content was not successfully received by the remote site due to the failure then transmit, after recovering from the failure, messages that include the second part; and wherein the second part may be detected using (a) at least one replication cycle identifier that identifies the replication cycle, and (b) at least one address of at least one logical entity portion.

The method may include recalculating, in response to the failure, the second part.

The method may include receiving, from the remote site, an address of a last logical entity portion of the first part and detecting a first logical entity of the second part.

The predefined order may be responsive to types of the portions.

The types of the portions may include (a) portions that may be cached by the local site but not stored in a permanent memory module of the local site, and (b) portions that may be stored in the permanent memory module of the local site.

The messages that may include the replication cycle content include the at least one replication cycle identifier that identifies the replication cycle and the at least one address of at least one logical entity portion.

The method further may include, repeating, for each replication cycle of multiple replication cycles the steps of: calculating, by the local site, the replication cycle content; attempting to transmit messages that include the replication cycle content to the remote site and according to a predefined order that may be responsive to addresses of the logical entity portions; and wherein when finding that the first part was successfully received by the remote site and the second part was not successfully received by the remote site due to the failure then transmitting, after recovering from the failure, messages that include the second part.

The replication cycle content represents all the differences in contents of logical entity portions between the point in time associated with the replication cycle and the point in time associated with the adjacent replication cycle that preceded the replication cycle.

The logical entity may be a logical volume, a portion of a logical volume, a consistency group or multiple logical volumes. A portion of the logical entity may be a logical unit used for difference calculation, be associated with any range of logical addresses, and the like.

The method may include monitoring a successful reception of the messages that include the second part of the replication cycle content by the remote site; and wherein when finding that a first segment of the second part of the replication cycle content was successfully received by the remote site and a second segment of the second part of the replication cycle content was not successfully received by the remote site due to an additional failure then transmitting, after recovering from the additional failure, messages that include the second segment of the second part.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a method according to an embodiment of the invention;

FIG. 2 illustrates a local storage system, a remote storage system, logical volumes maintained by the local and remote storage systems and various data entities according to an embodiment of the invention; and

FIG. 3 is a timing diagram illustrating a replication cycle according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

A local site may be a local storage system while a remote site may be a remote storage system that differs from the local storage system. Alternatively, both local and remote sites may reside in the same storage system and in this case each site is a portion of the storage system that includes at least one memory module. For simplicity of explanation it is assumed that the local site is a local storage system while the remote site is a remote storage system that differs from the local storage system.

According to an embodiment of the invention there is provided an asynchronous remote replication that is performed for replicating a source storage entity stored in a local site to a replicated storage entity in a remote site.

The storage entity may be a logical volume, a consistency group that includes multiple logical volumes for which consistency should be guaranteed, etc. The asynchronous remote replication is performed in recurrent replication cycles.

At a start of a replication cycle, which occurs at an n'th point in time, differences are calculated between a n'th point in time content of the logical volume and a previous (n−1)'th point in time content of the logical volume.

Optionally, a snapshot of the source logical entity is taken at the n'th point in time and the differences are compared between this snapshot and a previous (n−1)'th point in time snapshot of the source logical entity.

In case of an initial cycle, the entire content of the source logical entity is considered as a collection of differences to be conveyed to the remote site. The differences may be calculated using any other technique known in the art, other than comparing two successive snapshots.

The calculating may use a mapping data structure for mapping logical addresses within the storage entity into physical storage addresses where data is actually stored. Logical addresses in the mapping data structure may be associated with a timing value indicative of the last point in time in which the data associated with the logical addresses was modified.

The timing indication may be a cycle number or a snapshot version of the most recent snapshot existed when the data was written.

The mapping data structure may enable traversing logical addresses according to a predefined order (e.g., ascending order). For example, the mapping data structure may be an ordered tree with logical addresses as ordered keys.

Calculating the differences of a content of a replication cycle may include traversing the mapping data structure according to predefined order of logical addresses and obtaining logical addresses having a timing value that is greater than the end of the previous replication cycle.

Differences of a content of a replication cycle may be of a predefined equal size of data or may be of any variable size starting from one byte.

The content of a replication cycle is sent to the remote site by using one or more messages over a communication line that is used for transmitting replication information between the local site and the remote site.

Each replication cycle is identified by a replication cycle identifier, (e.g., n, wherein n is a sequence number of the replication cycle).

Each message transmitted during a replication cycle carries one or more differences of the content of the replication cycle. Each message may include the replication cycle identifier.

Each difference includes a portion of a logical volume that was changed in the local site since the previous replication cycle. The portion may be stored in a permanent storage unit of the local site or may be dirty cached data that was not yet written to the permanent storage unit but intended to be written to the permanent storage unit of the local site (and was acknowledged to a client or host computer that requested the modification).

A difference may include (or be associated with) an address within the local storage entity where the data is stored (or going to be stored if the data is still cached). The address may be a logical address within a volume. The address may include the identity of the logical volume (among other volumes included in the consistency group) and the logical address within that volume.

A set of differences of a content of a replication cycle is sent according to the predefined order of the addresses of the portions of the logical volumes associated with the differences.

For example, an ascending or descending order of the addresses, an ascending or descending or any other predefined order of volume identifiers and for each volume identifier—an ascending or descending order of the addresses within the corresponding volume.

The sending according to the predefined order may include sending dirty cached data before sending data stored in the volume, or sending dirty cached data after sending data stored in the volume.

Thus each difference that is sent from the local site to the remote site is associated with a replication cycle identifier as well as an address of the relevant logical volume portion.

The remote site may keep track of the received addresses and informs the local site when the order of receiving the addresses differs from the predefined order of transmission.

The replication process may be interrupted during a replication cycle due to communication failure, a failure of the local storage system or a failure of the remote storage system.

When the replication process restarts after reverting to operational state, there is no need to restore a previous consistent version of the replicated storage entity, so as to resume the replication from a consistent known point in time. Nor there is a need to resend the entire content of the replication cycle that was interrupted.

Instead, the remote site system may notify the local site about the last received difference prior to the failure, including the difference's address and the respective replication cycle identifier.

In response to receiving the notification about the last received difference, the local storage system may re-calculate, or obtain by using any other manner, the differences of the content of the replication cycle content that should be transmitted (starting from the last received difference) and maintain the predefined order of transmission.

The last received address is then identified in the differences.

The replication resumes with differences having addresses that follows (according to the predefined order) the last received address that was notified by the remote site.

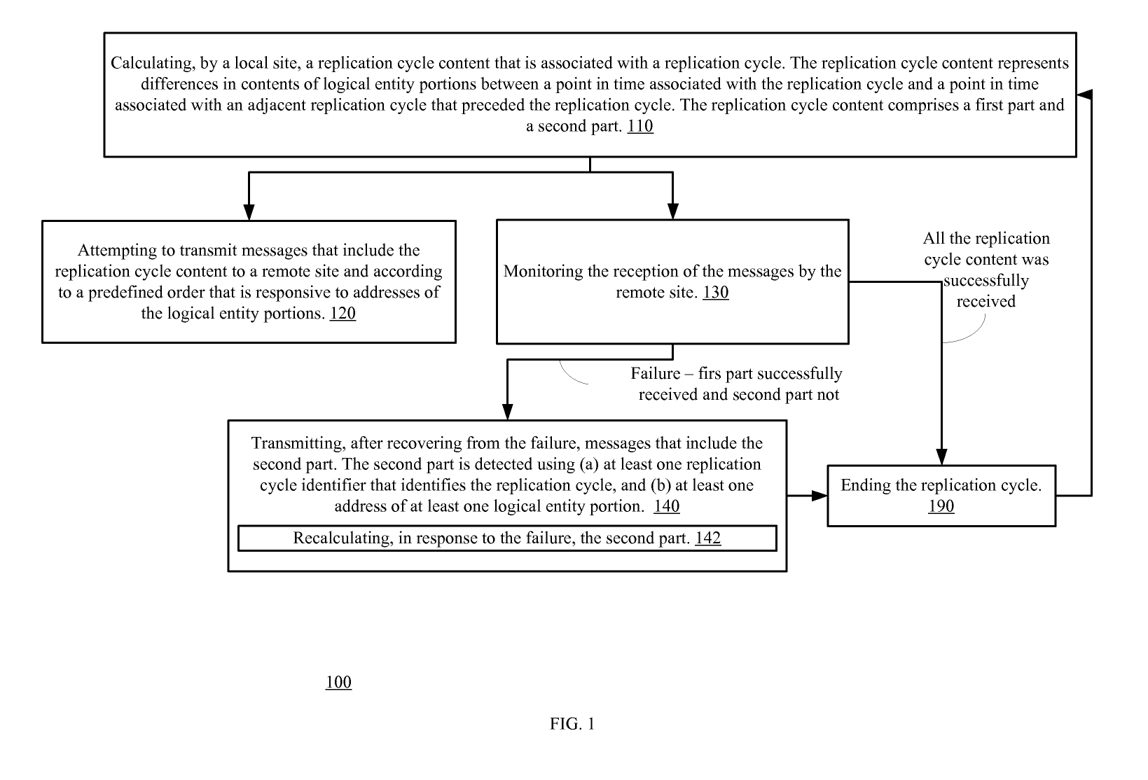

FIG. 1 illustrates method 100 according to an embodiment of the invention.

Method 100 may start by step 110 of calculating, by a local site, a replication cycle content that is associated with a replication cycle. The replication cycle content represents differences in contents of logical entity portions between a point in time associated with the replication cycle and a point in time associated with an adjacent replication cycle that preceded the replication cycle.

For example, assuming that index n is a positive integer and that an n'th replication cycle is associated with a n'th point of time content of a logical entity then the content of the n'th replication cycle represents differences in portions of the logical entity that occurred between the (n−1)'th point of time and the n'th point of time. The (n−1)'th point of time is associated with the (n−1)'th replication process. The n'th point of time may be the start time of the n'th replication cycle and the (n−1)'th point of time may be the start time of the (n−1)'th replication process.

Step 110 may be followed by steps 120 and 130.

Step 120 may include attempting to transmit messages that include the replication cycle content to a remote site and according to a predefined order that is responsive to addresses of the logical entity portions.

One or more messages may include the addresses of portions having differences that are included in the messages and/or may include a replication cycle identifier.

Additionally or alternatively, the addresses of the portions having differences that are included in the messages and/or the replication cycle identifier may be sent in other manners—for example using other messages, using other communication links and the like.

The predefined order may be known to the remote site (for example by sending to the remote site information about the predefined order) or may not be known to the remote site. In the former case it may be easier to the remote site to detect a failure that affects the replication cycle.

The predefined order may be irresponsive to types of the portions. Alternatively—the predefined order may be responsive to the types of the portions. The types of the portions may include, for example (a) portions that are cached by the local site but not stored in a permanent memory module of the local site, and (b) portions that are stored in the permanent memory module of the local site.

Step 120 may include traversing a mapping data structure that includes logical addresses and timing information related to write attempts of the logical entity portions associated with the logical addresses according to the predefined order.

Step 120 may include transmitting all the messages related to the replication cycle at once or transmitting the messages in an iterative manner.

Step 130 may include monitoring the reception of the messages by the remote site.

If the entire content of the replication cycle was successfully received by the remote site then step 130 is followed by step 190. Step 190 may include end the replication cycle.

If there is a new replication cycle to execute then step 190 may include jumping to step 110 for executing the new replication cycle. Thus, if there are multiple (N) replication cycles, then method 100 is repeated up to N times.

If step 130 indicates that a first part of the replication cycle content was successfully received by the remote site but a second of the replication cycle content part was not successfully received by the remote site due to the failure then step 130 is followed by step 140 of transmitting, after recovering from the failure, messages that include the second part.

The second part is detected using (a) at least one replication cycle identifier that identifies the replication cycle, and (b) at least one address of at least one logical entity portion. The detection of the second part includes detecting which differences associated with the replication cycle to send to the remote site. The detection may include detecting the first difference to be sent to the remote site.

According to an embodiment of the invention, step 140 may include step 142 of recalculating, in response to the failure, the second part. The recalculating utilize the replication cycle identifier and may be similar to the calculating of step 110, except that it determines only differences that follows the first difference to be sent to the remote site, according to the predefined order. For example, if the predefined order dictates ascending order of differences' addresses, then the recalculating may include traversing a mapping data structure for finding addresses whose value exceed the address of the first difference to be sent to the remote site and whose associated data was changed from a previous replication cycle that preceded the replication cycle that is identified by the replication cycle identifier. The second part includes all the differences with addresses that are larger than the address of the first difference to be sent to the remote site.

Step 130 may include receiving, from the remote site, an address of a last logical entity portion of the first part and step 140 may include detecting a first logical entity of the second part accordingly.

A successful completion of step 130 may be followed by step 190.

If, for example, the transmission of the second part only partially succeeds (another failure occurred) the method may include transmitting, after recovering from the additional failure, messages that include the reminder of the second part. The method may also include declaring a replication cycle failure, sending alerts to third parties (including an administrator of the local site and/or administrator of the remote site).

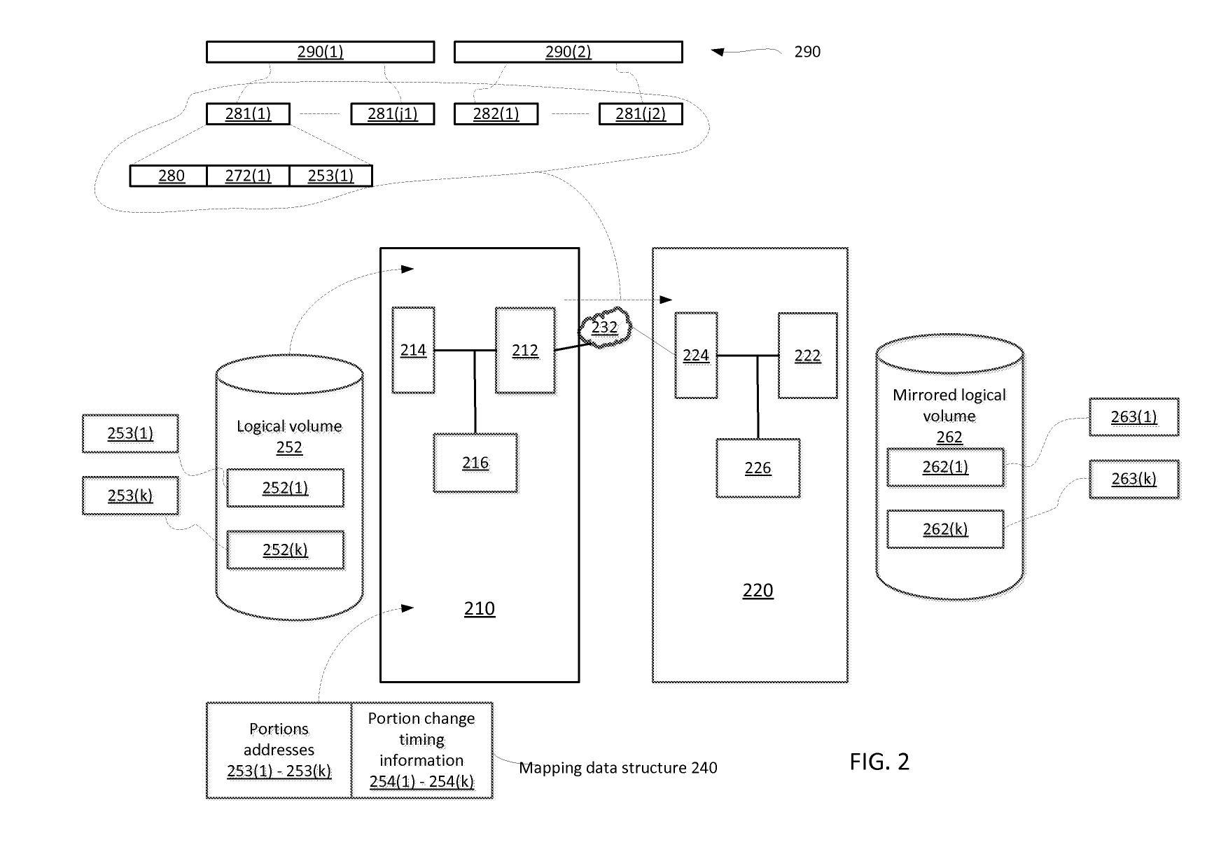

FIG. 2 illustrates:
A. A local storage system 210 having a local replication unit 212 and at least local one memory module such as local cache memory 214 and local permanent storage module 216.
B. A remote storage system 220 having a remote replication unit 222 and at least one remote memory module such as remote cache memory 224 and remote permanent storage module 226.
C. A logical entity such as logical volume 252 having multiple logical volume portions 252(1)-252(k). Each portion is associated with an address range 253(1)-253(k) of one or more logical addresses. The logical volume 252 is stored in the local storage system 210.
D. A mirrored logical entity such as mirrored logical volume 262 having multiple mirrored logical volume portions 262(1)-262(k). Each portion is associated with an address range 263(1)-263(k) of one or more logical addresses. The mirrored logical volume 262 is stored in the remote storage system 220.
E. Network 232 that is coupled between the local storage system 210 and the remote storage system 220.

The local storage system 210 may be configured to execute method 100.

FIG. 2 also illustrates a mapping data structure 240 that is maintained by the local storage system 210. The mapping data structure 240 maps addresses (253(1)-253(k)) of portions 252(1)-252(k) to physical addresses within local permanent storage module 216 and further includes portion change timing information 254(1)-254(k) indicating when the portion was last changed. If the last change of a portion was done before the previous replication cycle then it is not relevant for the current replication cycle. The local replication unit 212 may scan the mapping data structure 240 according to the predefined order, detect portions that are relevant, calculate differences (relevant differences) of the relevant portions and transmit the relevant differences according to the predefined order.

Each one of the local replication unit 212 and the remote replication unit 222 may include a hardware component such as a processor, a server, a computer, and the like.

FIG. 2 also illustrates messages 281(1)-281(j1) that include the first part 290(1) (of the content 290 of the replication cycle) and messages 282(1)-282(j2) that include the second part 290(2) (of the content 290 of the replication cycle). The first and second parts are not defined in advance. The content of the replication cycle is virtually partitioned to first and second parts by a failure that occurs between the successful reception (by the remote storage system) of the message 281(j1) that includes the last portion of the first part and the successful reception (by the remote storage system) of the message 282(1) that includes the first portion of the second part.

FIG. 2 also shows that message 281(1) includes:
A. A replication cycle identifier 280.
B. A difference 272(1) between content of the first portion 252(1) between the current replication cycle and the previous replication cycle of the logical volume.
C. An address 253(1) of the first portion 252(1). Although FIG. 2 illustrates that the message 281(1) carries only one difference, a message may include multiple differences of the cycle or a portion of a difference.

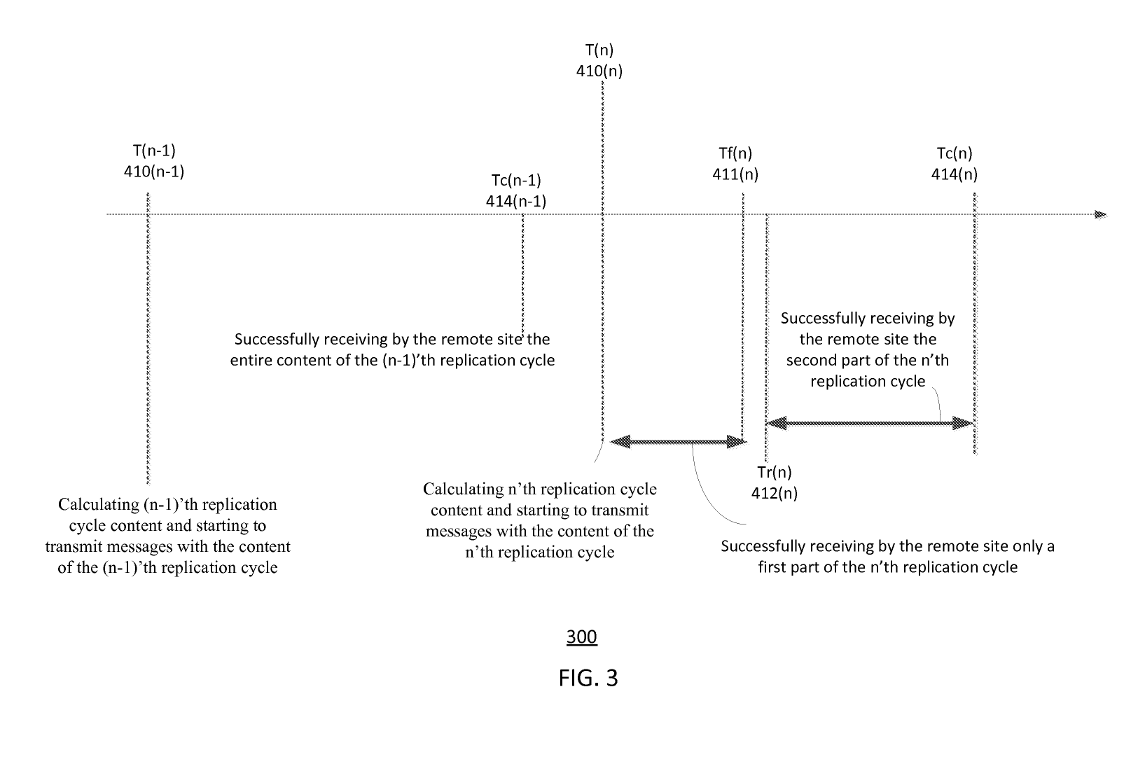

FIG. 3 is a timing diagram 300 illustrating a replication cycle according to an embodiment of the invention.

At a (n−1)'th point in time T(n−1) 410(n−1) the local storage system calculates the (n−1)'th replication cycle content, generates messages that include the content of the (n−1)'th replication cycle content and starts to transmit the messages to the remote storage system.

At Tc(n−1) 414(n−1) the entire (n−1)'th replication cycle content is successfully received by the remote storage system.

At an n'th point in time T(n) 410(n) the local storage system calculates the n'th replication cycle content, generates messages that include the content of the n'th replication cycle content and starts to transmit the messages to the remote storage system.

At Tf(n) 411(n) a failure occurred—after only a first part of the n'th replication cycle content was successfully received by the remote storage system.

At Tr(n) 412(n) a recovery process (from the failure) was completed and the local storage system starts to transmit messages that include a second part of the n'th replication cycle content.

At Tc(n) 414(n) the entire n'th replication cycle content is successfully received by the remote storage system.

The invention may also be implemented in a computer program for running on a computer system, at least including code portions for performing steps of a method according to the invention when run on a programmable apparatus, such as a computer system or enabling a programmable apparatus to perform functions of a device or system according to the invention.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein may be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for generating a remote replicate of a logical entity, the method comprises:
calculating, by a local site, a replication cycle content that is associated with a replication cycle; wherein the replication cycle content represents differences in contents of logical entity portions between a point in time associated with the replication cycle and a point in time associated with an adjacent replication cycle that preceded the replication cycle;
attempting to transmit messages that include the replication cycle content to a remote site and according to a predefined order that is responsive to addresses of the logical entity portions;
monitoring a successful reception of the messages that include the replication cycle content by the remote site; and
wherein when finding that a first part of the replication cycle content was successfully received by the remote site and a second part of the replication cycle content was not successfully received by the remote site due to the failure then transmitting, after recovering from the failure, messages that include the second part; wherein the second part is detected using (a) at least one replication cycle identifier that identifies the replication cycle, and (b) at least one address of at least one logical entity portion.

2. The method according to claim 1 comprising recalculating, in response to the failure, the second part.

3. The method according to claim 1 comprising receiving, from the remote site, an address of a last logical entity portion of the first part and detecting a first logical entity of the second part.

4. The method according to claim 1 wherein the predefined order is responsive to types of the portions.

5. The method according to claim 4 wherein the types of the portions comprise (a) portions that are cached by the local site but not stored in a permanent memory module of the local site, and (b) portions that are stored in the permanent memory module of the local site.

6. The method according to claim 1 wherein the messages that comprise the replication cycle content include the at least one replication cycle identifier that identifies the replication cycle and the at least one address of at least one logical entity portion.

7. The method according to claim 1 further comprising, repeating, for each replication cycle of multiple replication cycles the steps of:
calculating, by the local site, the replication cycle content;
attempting to transmit messages that include the replication cycle content to the remote site and according to a predefined order that is responsive to addresses of the logical entity portions; and
wherein when finding that the first part was successfully received by the remote site and the second part was not successfully received by the remote site due to the failure then transmitting, after recovering from the failure, messages that include the second part.

8. The method according to claim 1 wherein the replication cycle content represents all the differences in contents of logical entity portions between the point in time associated with the replication cycle and the point in time associated with the adjacent replication cycle that preceded the replication cycle.

9. The method according to claim 1 wherein the logical entity is a logical volume.

10. The method according to claim 1 further comprising monitoring a successful reception of the messages that include the second part of the replication cycle content by the remote site; and
wherein when finding that a first segment of the second part of the replication cycle content was successfully received by the remote site and a second segment of the second part of the replication cycle content was not successfully received by the remote site due to an additional failure then transmitting, after recovering from the additional failure, messages that include the second segment of the second part.

11. A non-transitory computer readable medium that stores instructions that once executed a local site causes the local site to execute the steps of: calculating, by a local site, a replication cycle content that is associated with a replication cycle; wherein the replication cycle content represents differences in contents of logical entity portions between a point in time associated with the replication cycle and a point in time associated with an adjacent replication cycle that preceded the replication cycle; attempting to transmit messages that include the replication cycle content to a remote site and according to a predefined order that is responsive to addresses of the logical entity portions; monitoring a successful reception of the messages that include the replication cycle content by the remote site; wherein when finding that a first part of the replication cycle content was successfully received by the remote site and a second part of the replication cycle content was not successfully received by the remote site due to the failure then transmitting, after recovering from the failure, messages that include the second part; and wherein the second part is detected using (a) at least one replication cycle identifier that identifies the replication cycle, and (b) at least one address of at least one logical entity portion.

12. The non-transitory computer readable medium according to claim 11 that stores instructions for recalculating, in response to the failure, the second part.

13. The non-transitory computer readable medium according to claim 11 that stores instructions for receiving, from the remote site, an address of a last logical entity portion of the first part and detecting a first logical entity of the second part.

14. The non-transitory computer readable medium according to claim 11 wherein the predefined order is responsive to types of the portions.

15. The non-transitory computer readable medium according to claim 14 wherein the types of the portions comprise (a) portions that are cached by the local site but not stored in a permanent memory module of the local site, and (b) portions that are stored in the permanent memory module of the local site.

16. The non-transitory computer readable medium according to claim 11 wherein the messages that comprise the replication cycle content include the at least one replication cycle identifier that identifies the replication cycle and the at least one address of at least one logical entity portion.

17. The non-transitory computer readable medium according to claim 11 that stores instructions for repeating, for each replication cycle of multiple replication cycles the steps of: calculating, by the local site, the replication cycle content; attempting to transmit messages that include the replication cycle content to the remote site and according to a predefined order that is responsive to addresses of the logical entity portions; and wherein when finding that the first part was successfully received by the remote site and the second part was not successfully received by the remote site due to the failure then transmitting, after recovering from the failure, messages that include the second part.

18. The non-transitory computer readable medium according to claim 11 wherein the replication cycle content represents all the differences in contents of logical entity portions between the point in time associated with the replication cycle and the point in time associated with the adjacent replication cycle that preceded the replication cycle.

19. The non-transitory computer readable medium according to claim 11 wherein the logical entity is a logical volume.

20. The non-transitory computer readable medium according to claim 11 further that stores instructions for monitoring a successful reception of the messages that include the second part of the replication cycle content by the remote site; and wherein when finding that a first segment of the second part of the replication cycle content was successfully received by the remote site and a second segment of the second part of the replication cycle content was not successfully received by the remote site due to an additional failure then transmitting, after recovering from the additional failure, messages that include the second segment of the second part

21. A local site that comprises a local replication unit and at least one memory module; wherein the local replication unit is configured to:
calculate a replication cycle content that is associated with a replication cycle and i stored in the at least one memory module; wherein the replication cycle content represents differences in contents of logical entity portions between a point in time associated with the replication cycle and a point in time associated with an adjacent replication cycle that preceded the replication cycle;
attempt to transmit messages that include the replication cycle content to a remote site and according to a predefined order that is responsive to addresses of the logical entity portions;
monitor a successful reception of the messages that include the replication cycle content by the remote site;
wherein when finding that a first part of the replication cycle content was successfully received by the remote site and a second part of the replication cycle content was not successfully received by the remote site due to the failure then transmit, after recovering from the failure, messages that include the second part; and
wherein the second part is detected using (a) at least one replication cycle identifier that identifies the replication cycle, and (b) at least one address of at least one logical entity portion.
